(19) United States
(12) Patent Application Publication
(10) Pub. No.: US 2005/0062638 A1
(43) Pub. Date: Mar. 24, 2005

(54) Missile deflector for airplanes

(76) Inventor: Rashid A. Zeineh, Fullerton, CA (US)

Correspondence Address: Rashid A. Zeineh, 1511 Alto Lane, Fullerton, CA, 92831, US

(21) Appl. No.: 10/668,519

(22) Filed: Sep. 24, 2003

(51) Int. Cl. G01S 7/36

(52) U.S. Cl. 342/13; 342/14; 89/1.1; 250/495.1; 342/53; 342/9

(57) ABSTRACT

The present invention relates to flying airplane security during landing or taking off from the risk of surface to air missiles fired by shoulder held launchers as the heat seeking Stinger or SAM-18 missile. In Kenya two stinger missiles attempted to down an Arkia Israeli airliner carrying tourists. Stinger or SAM-18 surface to air missile available on black market and fired from shoulder-held launcher with heat seeking guidance head might be deadly to low flying passengers planes worldwide, the USA included. This missile deflector system positioned at the rear belly of the plane comprises a missile detector and a decoy IR light source sprung to trail the plane. The detector can be an infrared-daylight video camera with a fisheye lens, a flying laser spot, a flying line laser, a range finder, and with software for motion detection. The decoy heat source sprung from the socket dangles below and behind the plane or just behind it and generates intense IR to distract the missile away from the engine and renders safety whether detonation occurs or not.

### TECHNICAL FIELD

The present invention relates to airplane's safety against possible terror attack by a ground shoulder-held missile launcher. In Kenya two Stinger missiles attempted to down an Arkia Israeli airliner carrying tourists. Now with SAM-18 surface to air Russian missile fired from shoulder-held launcher with heat seeking tip and guidance might be deadly to low flying passengers plane flying 15,000 feet or two miles altitude can be downed on approach to land or going away after take off.

### BACKGROUND ART

At present, war planes can evade SAM-6, SAM-18, Stinger by being high flying, maneuverable to dive and recover back straight while the incoming SAM can not follow the sharp upward flying of the war plane. Commercial and passengers planes are not maneuverable and at risk against the deadly shoulder held launchers. Also war planes are equipped with radar to detect incoming missiles and disperse heated metal foils to distract the missile away from the engine that generates lower density or infra red power.

### DISCLOSURE OF THE INVENYION

The present invention relates to security in-flight airplanes from surface to air missiles as those of shoulder held launchers for stinger or SA-18 Russian missile. In Kenya two stinger missiles attempted to down an. Arkia Israeli airliner carrying tourists. The risk from stinger type or SAM-18 surface to air Russian missile fired from shoulder-held launcher with heat seeking guidance head might be deadly to low flying passengers plane flying 15,000 feet or two miles altitude that can be downed on approach to land or after take off. The missile deflector comprises passive infrared-daylight video camera with fish lens or with flying laser spot or line laser or range finder with software for motion detection plus heat source, infra red flung from the lower body end of the plane near the tail. The heat source connected to the body of the plane can be manually or automatically flung at landing or at take off away from the plane during altitude range of 100-18,000 feet. The motion detector or the IR sensor program can cause the heat source to extend or fling from the plane using mini cup parachute-like to pull the heat source 100 feet lower than the plane and 100 feet or more behind the plane or just 100 feet or more behind the plane not below it. The incoming missile intended for the airplane engine is deflected away to the heat source where the proximity or direct contact fuse does not ignite to explode the missile explosives. The IR light source is brighter than that of the engine and can be a single wavelength or a group of sources emitting various IR wavelengths, or a light source of the same spectrum or profile of that of the engine. The spectrum or the profile of IR emitted by the engine can be determined by emission plate spectroscopy or emission scanning of the running engine. The decoy light source can be heat emission profile similar to that of the engine. The use of hot flares thrown behind the plane as used in the military jets might be hazardous when used by a low flying slow civilian plane due to the possibility of starting fire at ground especially close to wooded area.

### BRIEF DESCRIPTION OF THE DRAWINGS

FIG. 1. Landing or taking off airplane 20, with engine 21 emitting infra red heat waves 22, an approaching heat seeking missile 23 is fired by a person on ground towards the plane. An Infra red heat source 26 below light reflector 25 emits infra red heat waves 27 that are stronger or denser than heat waves 22 emitted by the airplane engine. The decoy heat waves 27 distract s the incoming missile 30. Visible—infra red camera 28 with fisheye lens sees approaching objects and triggers the release of IR source decoy distracter 26 as the missile gets close to the plane.

FIG. 2. Terrorist 31 in the vicinity on the ground 32 aims the shoulder-held missile launcher 33 using targeting viewer 34 to shoot the missile with the heat seeker head 35.

FIG. 3. Landing or taking off plane with bright IR light source 25 dragging behind.

FIG. 4. IR bright light source 25 inside a symmetrical double cone casing of IR transparent material or glass 36 towed by 24 cable attached to the rear of the plane. Cup 37 is a horizontal stabilizer and steel vertical stabilizer 38 acting as a keel.

### DETAILED DESCRIPTION OF THE DRAWINGS

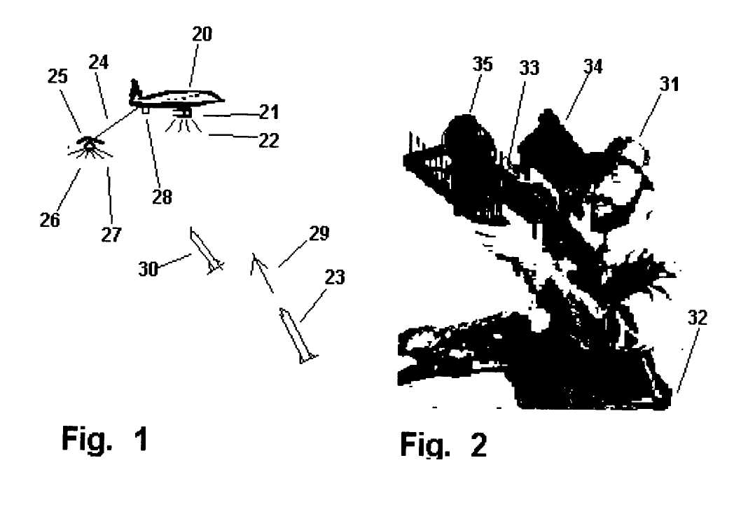

FIG. 1. Low flying landing or taking off airplane 20 is targeted by a ground based person 31 carrying a shoulder held launcher 33. The fired missile 23 is directed towards the plane and supposed to be attracted to the heat 22 generated by engine 21. The missile is expected to physically hit engine 21 which is emitting infra red heat waves 22. But with decoy heat generating IR source 25 the approaching heat seeking missile 23 fired by a person on ground sees a competing IR source of Infra red heat source 25 and goes to the decoy's strong IR source 26 deflecting the missile to itself. The decoy IR source 26 below a light reflector 25 reflects the emitted infra red heat waves 27 that are stronger or denser than heat waves 22 emitted by the airplane engine 21 to distract the incoming missile away from the targeted engine. A visible—infra red camera 28 located at the bottom side of the plane's belly with fisheye lens sees the approaching missile by means of motion detection or motion analysis computer program, or by range finder, flying laser spot, or flying line laser. As the computer detects motion through subtracting one image from the second, the computer commands the forced release of the decoy light source 25 from its socket to the outside The released decoy IR source held by electrical cable hangs below and behind the airplane. This decoy light source distracts the incoming missile towards the decoy light source away from the engine 21. Stinger or SAM-18 type missiles fired by shoulder held launcher are usually none-proximity fuse but rather direct contact fuse causing the missile to miss the engine and not explode by the virtual realty of IR source decoy.

FIG. 2. Terrorist 31 in the vicinity of the airport or on a hill below the landing or the take off path on ground 32 aims the shoulder-held missile launcher 33 using targeting viewer 34 and the indicator of optimal aiming direction to shoot the missile towards the plane. The missile heat seeker head 35 leaves the launcher half blindly towards the airplane. As it gets close to the plane the heat seeker starts to follow towards the heat-generating engine. With the flaring or flying heat source decoy 25 that has more concentrated heat or more intense infra red light distracts the incoming missile away from the engine. The missile misses the plane and the engine. If the missile has proximity fuse the explosion is far from the body of the plane and the terror is mitigated.

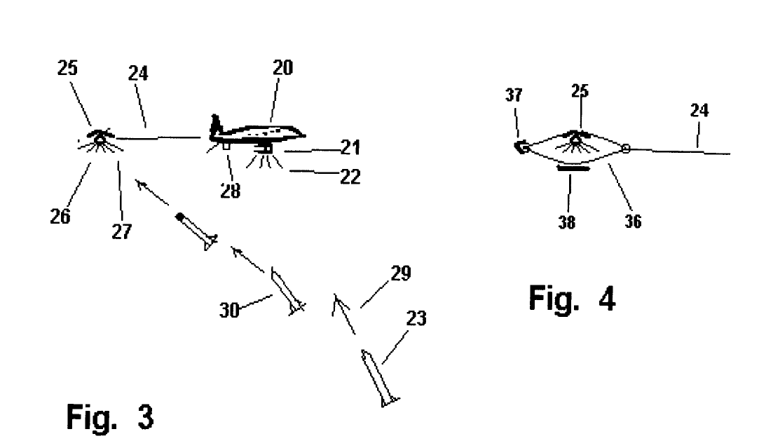

FIG. 3. Landing or taking off plane with bright IR light source 25 dragging behind the flying plane and heat seeking missile 23 is aimed by the view finder of the launcher towards the plane or towards the engine 29 but direction 30 is attracted by the brighter IR light source 25. If the missile explode at the light source 25, the explosion will not damage the plane.

FIG. 4. IR bright light source 25 inside a symmetrical double cone casing of IR-transparent material or glass 36 towed by cable 24, which is anchored or attached to the rear of the plane. Cup 37 is a horizontal stabilizer be resistance to airflow. The casing is attached to steel or heavy material stabilizer 38 for vertical stabilization of the casing acting as a keel.

1. A missile deflector system consisting of a sensor and infra red light source placed in the rear part of the airplane belly. The sensor is IR-visible video camera with fish eye lens connected to a computer motion analysis software to detect incoming missile and a mechanical release system that throws out the decoy IR light source to float below and behind or just behind the plane and the electrical cable physically dragging the decoy is supplied with electrical power to generate the IR intense light by the decoy.

2. As in claim 1 where the decoy infra red intense light source is manually released shortly after take off and is retracted shortly before landing.

3. As in claim 1 where the decoy infra red intense light source is automatically ejected at 100 feet altitude on take off and is retracted at 18,000 feet altitude.

4. As in claim 1 where the decoy infra red intense light source is automatically ejected at 18,000 feet altitude on landing and is retyracted at 200 feet altitude.

5. As in claim 1 where the decoy infra red light source release is triggered by a radar system on the plane upon detection of incoming missile.

6. As in claim 1 where the sensor is a motion detector radar system mounted on the plane.

7. As in claim 1 where the sensor is a range finder with wide viewing angle.

8. As in claim 1 where the sensor is a motion detector and the decoy is heated foils thrown in the air behind the plane.

9. As in claim 1 where the decoy light source is multiple IR light sources.

10. As in claim 1 where the decoy a multiple IR sources of emission profile similar but stronger than that of the engine.

11. As in claim 1 where the decoy light source in enclosed in a cylindrical shape container with cone shaped ends and with its rear end connected to a hard material of parachute shape for horizontal stabilization, and with a heavy rod material affixed to its bottom part for vertical stabilization.
